(19) United States
(12) Patent Application Publication
(10) Pub. No.: US 2005/0224286 A1
(43) Pub. Date: Oct. 13, 2005

(54) Descending device hanging structure

(76) Inventor: Fan Po Hsun, Taipei Hsien (TW)

Correspondence Address: Fan Po Hsun, PO Box 82-144, Taipei, TW

(21) Appl. No.: 10/820,780

(22) Filed: Apr. 9, 2004

(51) Int. Cl. A62B 1/06

(52) U.S. Cl. 182/70

(57) ABSTRACT

A descending device hanging structure adapted to hang a descending device on a window for helping a person to escape from a danger is disclosed to include a first rod member for the hanging of the safety hook of a descending device, a second rod member for supporting the safety hook of the descending device to be hung to the first rod member, and a plurality of fastening devices respectively provided at the first rod member and adapted to secure the second rod member to the first rod member after the first rod member and the second rod member have been respectively transversely stopped at the inner and outer sides of a window.

### BACKGROUND OF THE INVENTION

1. Field of the Invention

The present invention relates a descending device and more particularly, to a hanging structure for hanging a descending device on a window for enabling the user to escape from a danger.

2. Description of the Related Art

In most countries, every building where the residence is over a certain number must be equipped with a certain amount of descending devices so that residents can escape from a high place of the building upon a fire, and the balcony of each house of every story of the building must be provided with a descending device hanging structure for hanging a descending device to held people escape from the fire. Conventionally, a descending device hanging structure comprises a fixed upright fixedly fastened to the floor of the balcony, and a hanging arm fastened pivotally with the top side of the upright right for the hanging of a descending device. When not in use, the hanging arm is turned downwards and closely attached to the upright, and therefore the descending device hanging structure is received in a substantially I-shaped status. When in use, the hanging arm is turned outwards from the upright to a horizontal position perpendicularly extended from the top side of the upright, i.e., the descending device hanging structure is arranged into an invertedly disposed L-shaped status for hanging the descending device outside the balcony. Because the descending device hanging structure is fixedly fastened to the floor of the balcony, it cannot be removed from the balcony and stored inside the house when not in use.

### SUMMARY OF THE INVENTION

The present invention has been accomplished under the circumstances in view. It is the main object of the present invention to provide a descending device hanging structure, which can be received together to reduce space occupation when not in use. It is another object of the present invention to provide a descending device hanging structure, which can conveniently and quickly be installed in the window of the building in trouble for hanging a descending device. To achieve these and other objects of the present invention, the descending device hanging structure comprises a first rod member for the hanging of the safety hook of a descending device; a second rod member for supporting the safety hook of the descending device to be hung to the first rod member; and a plurality of fastening devices respectively provided at the first rod member and adapted to secure the second rod member to the first rod member after the first rod member and the second rod member have been respectively transversely stopped at inner and outer sides of a window.

### BRIEF DESCRIPTION OF THE DRAWINGS

FIG. 1 is an exploded view of a descending device hanging structure according to the present invention.

FIG. 2 is an applied view of the present invention, showing the descending device hanging structure installed in a window.

FIG. 3 is a sectional plain view of FIG. 3.

### DETAILED DESCRIPTION OF THE INVENTION

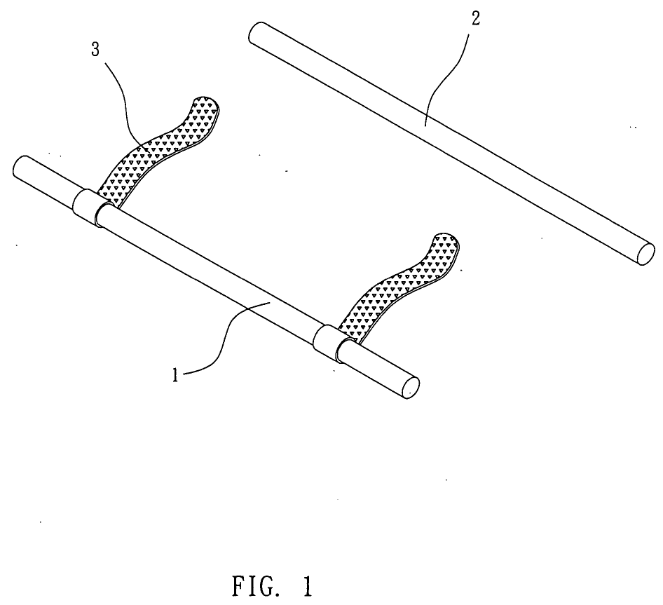

Referring to FIG. 1, a descending device hanging structure in accordance with the present invention is shown comprised of a first rod member 1, a second rod member 2, a plurality of fastening devices 3 provided at the first rod member 1. The fastening devices 3 can be fastening ropes, or belts of hook and loop materials. When belts of hook and loop materials are used, each belt has hook material at one side and loop material at the other side. By means of fastening the respective hook materials to the respective loop materials, the belts of hook and loop materials are secured to the first rod member 1 and the second rod member 2 to hold the first rod member 1 and the second rod member 2 in parallel. When fastening ropes are used, fastening ropes are directly tied to the first rod member 1 and the second rod member 2.

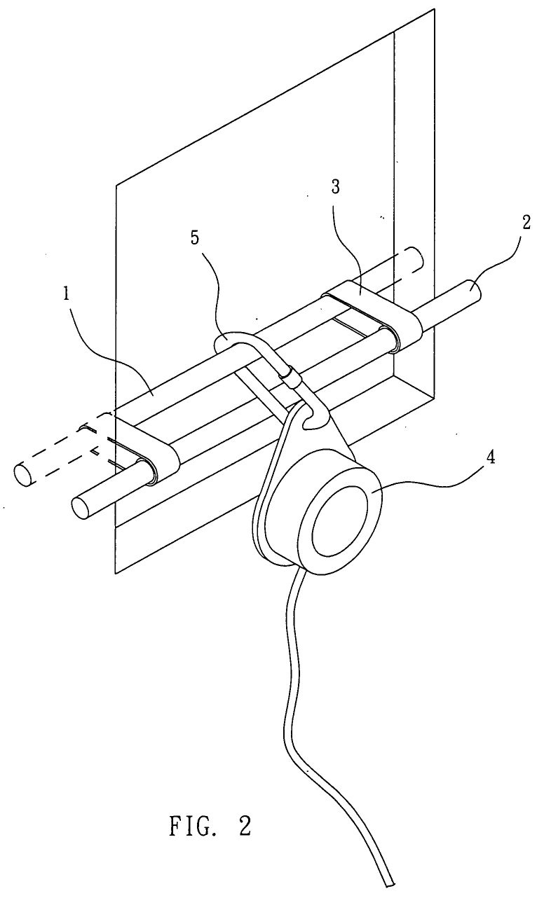

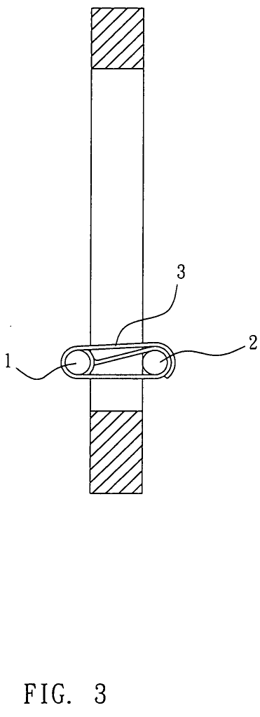

Referring to FIGS. 2 and 3, the first rod member 1 and the second rod member 2 are transversely stopped at the inner and outer sides of the window and fixed in place by the fastening devices 3, and then the safety hook 5 of the descending device 4 is fastened to the first rod member 1 and supported on the second rod member 2. At this time, the user can use the descending device 3 to escape quickly from a danger.

Although a particular embodiment of the invention has been described in detail for purposes of illustration, various modifications and enhancements may be made without departing from the spirit and scope of the invention. Accordingly, the invention is not to be limited except as by the appended claims.

1. A descending device hanging structure adapted to hang a descending device on a window for helping a person to escape from a danger, the descending device hanging structure comprising:
a first rod member for the hanging of the safety hook of a descending device;
a second rod member for supporting the safety hook of the descending device to be hung to said first rod member; and
a plurality of fastening devices respectively provided at said first rod member and adapted to secure said second rod member to said first rod member after said first rod member and said second rod member have been respectively transversely stopped at inner and outer sides of a window.

2. The descending device hanging structure as claimed in claim 1, wherein said fastening devices are belts of hook and loop materials.

3. The descending device hanging structure as claimed in claim 1, wherein said fastening devices are tie ropes.
